(19) United States
(12) Patent Application Publication
(10) Pub. No.: US 2006/0150081 A1
(43) Pub. Date: Jul. 6, 2006

(54) Method for operating a field device using a browser

(76) Inventors: Andrea Seger, Schopfheim (DE); Joachim Giebel, Schopfheim-Wiechs (DE); Martine Lefebvre, Blotzheim (FR)

Correspondence Address: Bacon & Thomas, 4th Floor, 625 Slaters Lane, Alexandria, VA, 22314-1176, US

(21) Appl. No.: 10/523,785

(22) PCT Filed: Sep. 25, 2002
(86) PCT No.: PCT/EP02/10717

§ 371 Date: Jan. 10, 2006

(30) Foreign Application Priority Data
Sep. 27, 2001 (DE) 101 47 706.6

(51) Int. Cl. G06F 17/21; G06F 17/00

(52) U.S. Cl. 715/513; 715/705

(57) ABSTRACT

A method for operating a field device, which is connected by way of a data bus with a control system, by means of a graphical user interface and a device description file for a field device, the device description file includes two components, a data component and a presentation component, which are loaded together dynamically at run time into a browser, wherein the data component and the presentation component are produced together as a device description file, and the presentation component can be matched exactly to the functionality of the field device. In this way, the operation of a field device is considerably simplified.

The invention relates to a method for operating a field device.

In the current practice of automation technology, field devices are applied for registering and/or influencing process variables. Examples of such field devices are fill level measuring devices, mass flow meters, pressure gages, thermometers, etc., which register the corresponding process variables of fill level, mass flow rate, pressure, and temperature, respectively. Serving for influencing process variables are so-called actors, which e.g. act as a valve for controlling the flow of a liquid in a section of a pipeline.

Field devices are, as a rule, connected over a data bus with a control- or engineering-system, which controls the total course of a process or enables a direct access for operating, parametering or configuring the individual field devices, as the case may be. By the direct access, settings (e.g. parameters) can be changed at the field device, or special diagnosis functions can be activated. Besides access via the control system, an occasional access is also possible, e.g. via a handheld operating device, portable computer or a mobile phone. In the control system, the measured values of the different process variables are evaluated, or monitored, as the case may be, and the appropriate actors are controlled.

Data transfer between field device and control system occurs on the basis of known international standards for field busses, such as e.g. Hart, Foundation Fieldbus, Profibus, CAN, etc. Besides a cable connection, also a radio connection between field device and control system is conceivable.

Before start-up, settings (parametering) must be done at the field device, even via an on-site procedure, or over the data bus. For parametering over the data bus, the individual field device manufacturers provide operating- or, as the case may be, configuration-tools. These programs are manufacturer specific and usually allow only the accessing of the field devices of the particular manufacturer.

In the case of today's automation installations, frequently a number of field devices of different manufacturers are used. The accessing of foreign devices is only possible with reservations. In order to enable the operation of different field devices using one control system, the control system must know the functionality of each field device. To date, the functionality of a field device has been described by means of a device description. For this purpose, special standardized device description languages are available, examples being CAN—EDS (Control Area Network—Electronic Data Sheet), Hart—DDL (Hart—Device Description Language), Prof ibus—GSD (Prof ibus—Device Database), Profibus—EDD (Profibus—Electronic Device Description). Device descriptions to date contain mostly only information in text form.

The operation of a field device from the control- or engineering-system occurs mostly via a graphical user interface (GUI), which facilitates the start-up, maintenance, data protection, problem resolution and device documentation. The GUI is, as a rule, created by the system manufacturer. Of disadvantage in this is the fact that the device description and the control system with its GUI are supplied by different manufacturers, and, consequently, are not matched to one another. In the programming of a control- or engineering-system, no manufacturer-specific field device characteristics can be taken into consideration. A further disadvantage of the known device descriptions resides in that special functions of a field device, such as e.g. the drawing of an echo-curve of a radar fill level measuring device, can not be presented. If the device descriptions are present in machine language (binary code) and are integrated in system applications, then it can happen that errors occur during program execution. In the extreme case, such errors can lead to a system crash.

Some device descriptions can, it is true, be applied in distributed systems by means of DCOM-technology, but here one is limited just to platforms which support Microsoft-DCOM. Platform independence is not provided in the case of the known device descriptions.

It is also known that the production of device descriptions is very expensive using conventional means. There is e.g. no possibility for validation or syntax testing during their production.

An object of the invention, therefore, is to provide a method for operating a field device not having the above-described disadvantages and especially to provide a field device operating GUI which is matched to the field device.

This object is accomplished by a method for operating a control-system-connected field device by means of a graphical user interface (GUI) and a device description file, characterized in that the device description file includes two components, a data component and a presentation component, which can be loaded dynamically together at run time into a browser to provide the GUI. Because the data component and the presentation component are produced together as the device description file, the presentation component can be matched exactly to the functionality of the field device.

Advantageous further developments of the invention are described in the dependent claims.

In one further development of the invention, the data component of the device description is described in the form of an XML-file and the presentation component as an XSL-file, and these are loaded as an HTML-page in a browser at run time. In XML (eXensible Markup Language), structured data is represented easily and platform-independently. XSL (extensible Style Language) cares for the presenting of data from XML-files.

Advantageously, the run time environment is in a Microsoft platform.

In a further development of the invention, the presentation component includes pictures of the relevant process component, together with the field device.

In a further development of the invention, the presentation component is stored in the form of spoken text.

In a further development of the invention, the GUI contains links, which invoke an online help.

The invention will now be explained in greater detail on the basis of an example of an embodiment presented in the drawings, which show as follows:

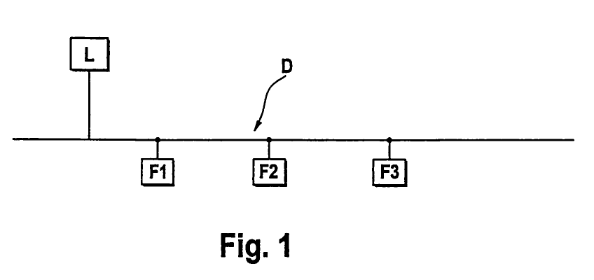

FIG. 1: An automation installation including a plurality of field devices

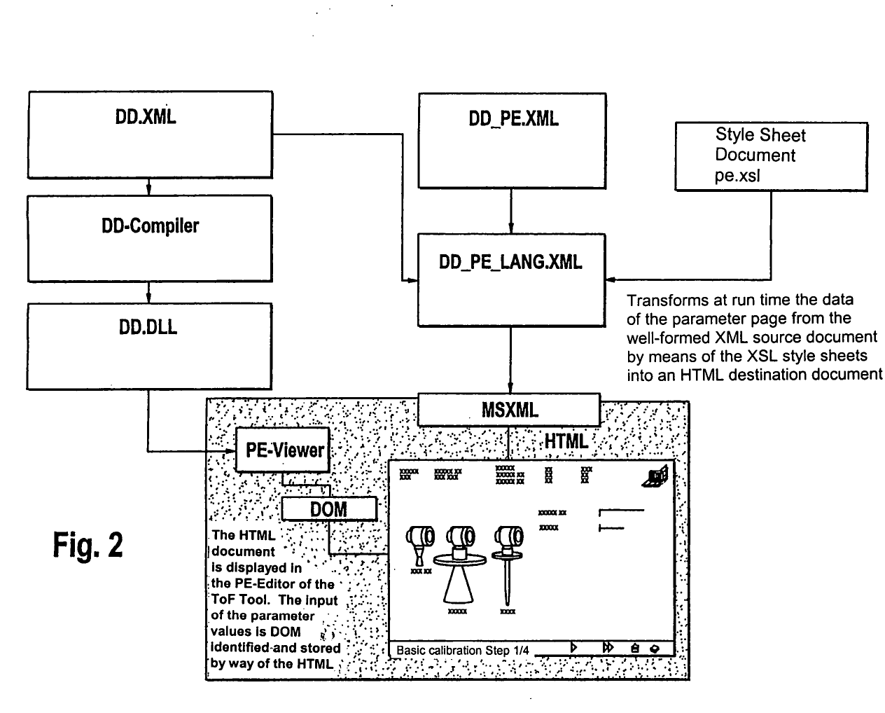

FIG. 2: Schematic flow diagram for producing a device description with corresponding HTML-page

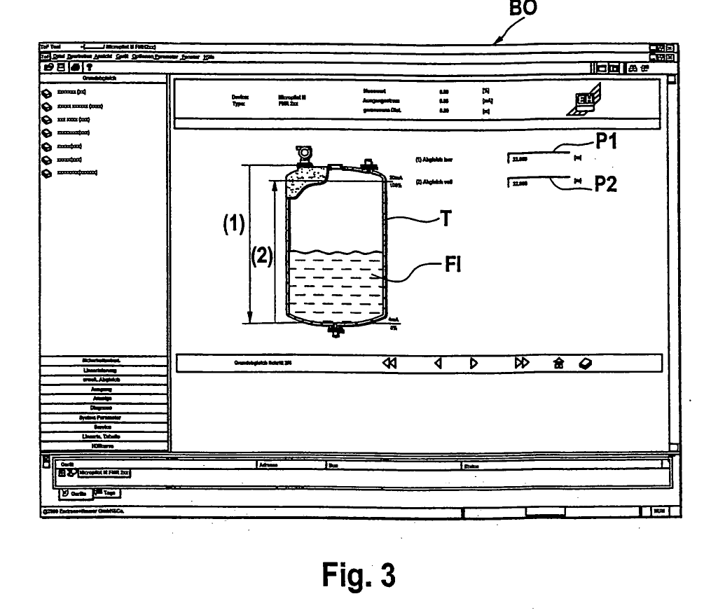

FIG. 3: Graphical user interface

The automation installation presented in FIG. 1 shows a control system L, which is connected via a data bus D with a plurality of field devices F1, F2 and F3. The field devices F1 to F3 can be e.g. a pressure gage, a thermometer or a flow rate meter. The control system L communicates over the data bus D with a chosen field device, e.g. F1. Through this, data can be transferred between the field device and the control system. Data communication on the field bus occurs according to appropriate international standards, such as e.g. Profibus, CAN or FF. The operation of the field device, i.e. its start-up, maintenance, data protection, problem resolution and device documentation, is accomplished by way of a GUI from the control system.

FIG. 2 is a schematic flow diagram for the production of a device description according to the invention. The file DD.XML contains the description of parameters (label, type, etc.) for a field device e.g. F1, F2 or F3. A DD-compiler produces a device description file DD.DLL (Dynamic Link Library) from the description present in text form in XML.

A file DD_PE.XML describes the menu, the page sequences, the number of parameters, graphics, pictures, etc., from which, together with the file DD.XML, a file DD_PE_Lang.XML is produced. This file is the data component.

The file pe.xs1, which is the presentation component, stores the style sheets.

According to the method of the invention, an HTML-page, providing a graphical user interface (GUI) BO (FIG. 3), is produced dynamically from the XML document (data component) and the XSL style sheets (presentation component) at run time by means of an appropriate browser (Internet Explorer, Netscape). The GUI BO shows, for illustration and for facilitating the operation of the field device, the process component coupled with the field device. With reference to FIG. 3, one essentially sees a tank T filled with a liquid F1, a field device F1 and the input mask for the two parameter values P1, P2 needed for the calibration of the field device F1 (e.g. a radar fill-level measuring device). The two parameters P1 and P2 are explained graphically on the GUI BO. Thus, the meaning of the two parameters P1 and P2 is unequivocally clear for the user. This prevents errors during the parametering. Such errors can have negative effects as regards process safety.

Along with the graphic explanation, a oral explanation is also possible. This permits an even better guiding of the user during operation. Should the user, despite the graphical, or, as the case may be, oral explanation, still be unclear as to the meaning of the parameter, or parameters, P1 or P2, he or she can invoke an online/offline help by clicking the appropriate text “empty calibr.” (Parameter Pi) or “full calibr.” (Parameter P2) to obtain additional information.

The run time environment is preferably a Microsoft platform.

Besides the parameter names, the data component can also contain event- and alarm-texts, as well as additional, coded information.

The parameter values (P1, P2) entered by way of the HTML-page can be identified and stored by means of a parameter editor (PE) operating according to the DOM-standard (Document Object Model).

A significant advantage for production of a device description in XML is that XML can be generated easily. Additionally, when the device description is in XML, the syntax of the device description can be checked. This enables the quality of the device descriptions to be considerably improved.

Moreover, XML is supported by various operating systems. Use of the XSL style sheet means that the GUI can be matched exactly to the field device, which considerably simplifies start-up, maintenance, simulation, data protection, problem resolution, device documentation, etc. of a field device.

1-9. (canceled)

10. A method for operating a field device, which is connected by way of a data bus with a control system, by means of a graphical user interface (GUI) and a device description file for the field device, comprising the step of:
loading the device description file having two components, a data component and a presentation component, together dynamically at run time into a browser.

11. The method as claimed in claim 10, wherein:
the data component is an XML-file and the presentation component is an XSL-file.

12. The method as claimed in claim 10, wherein:
the run time environment is a Microsoft platform.

13. The method as claimed in claim 10, wherein:
the data component contains parameter names, event- and alarm-texts, coded additional information, etc.

14. The method as claimed in claim 10, wherein:
the presentation component contains information for visualizing and explaining the process component of concern.

15. The method as claimed in claim 10, further comprising the step of: providing dynamic, relevant links on the GUI for invoking an online/offline help.

16. The method as claimed in claim 10, wherein:
the operation includes start-up, maintenance, simulation, data protection, problem removal and device documentation.

17. The method as claimed in claim 10, further comprising the step of:
using the Internet Explorer of Microsoft® as the browser.

18. The method as claimed in claim 10, further comprising using the Netscape Navigator of Netscape as the browser.
